(19) United States
(12) Patent Application Publication
(10) Pub. No.: US 2004/0025033 A1
(43) Pub. Date: Feb. 5, 2004

(54) System and method for preventing unauthorized installation, use and reproduction of software

(76) Inventor: Luke B. Todd, Centerville, UT (US)

Correspondence Address: Steve M. Perry, THORPE, NORTH & WESTERN, L.L.P., P.O. Box 1219, Sandy, UT, 84091-1219, US

(21) Appl. No.: 10/211,221

(22) Filed: Aug. 2, 2002

(51) Int. Cl. H04L 9/32; H04L 9/00; H04K 1/00

(52) U.S. Cl. 713/189; 705/56

(57) ABSTRACT

A method for preventing unauthorized installation of computer software stored on an install storage medium, comprising the steps of initiating communication between a key storage medium and a computer onto which the software is to be installed, verifying that file attributes of files stored on the key storage medium correspond to file attributes defined by the software contained on the install storage medium, and authorizing installation of the computer software from the install storage medium onto the computer. The method can include the step of verifying that disk attributes of the key storage medium correspond to disk attributes defined by the software.

### BACKGROUND OF THE INVENTION

1. Field of the Invention

The present invention relates generally to a method for preventing unauthorized installation, use and reproduction of software.

2. Related Art

Piracy, or the unauthorized installation and use of software, has become a problem with which nearly all developers of software must contend. When a consumer purchases a copy of a particular software title, he or she is generally given a limited-use license which dictates how many copies of the software the consumer is authorized to install and use. When a consumer installs or uses copies of the software beyond the number authorized by the license, he or she has pirated the software. The software industry estimates that billions of dollars are lost each year due to pirating of software.

Because software piracy has reached such proportions, it is no surprise that the software industry has actively attempted to combat piracy. One such attempt has included requiring that the original installation disk or medium be present in the computer in order for the software program to run. This has been generally ineffective due to the fact that hackers have been able to circumvent this copy protection method. Consumers are also unsatisfied with this result because of the inconvenience of locating the proper disk each time the software is run, and because other disks, such as music CDs, cannot be played while running the software.

Another solution that has been attempted is requiring that a hardware key or “dongle” be present in order for the software to be run. This has proved inconvenient because operators must always have access to the dongle, and must locate and use the dongle each time the software is run. Operators must inconveniently carry the dongle to and from multiple computers to which the operator has a legal right to install multiple copies of the software. Also, use of a primary dongle increases the costs associated with the software program.

Another solution that has been attempted is to require a floppy disk that records computer-specific information about the computer or computers onto which the software has been installed. In this scenario, the floppy authorizes use of the software on computers which have been recorded on the floppy as authorized computers for use of the software. The computer-specific information might be, for example, hardware IDs, serial numbers from processors or hard-drives, or other IDs such as an operating system serial number or BIOS information. This solution has proved difficult in that changes that are often made to computers, such as upgrading software and hardware, and this interferes with proper use of the software protection scheme.

### SUMMARY OF THE INVENTION

The invention provides a method for preventing unauthorized installation of computer software stored on an install storage medium, and includes the steps of: initiating communication between a key storage medium and a computer onto which the software is to be installed; verifying that file attributes of files stored on the key storage medium correspond to file attributes defined by the software contained on the install storage medium; and authorizing installation of the computer software from the install storage medium onto the computer.

In accordance with a more detailed aspect of the present invention, a method is provided for preventing unauthorized use of a software program installed on a computer, comprising the steps of: reading a current date from the computer and verifying that the current date corresponds to a target date defined by the software program; initiating communication between the computer and a key storage medium; verifying that file attributes of files stored on the key storage medium correspond to file attributes defined by the software program; and authorizing execution of the computer software by the computer.

In accordance with a more detailed aspect of the present invention, a method is provided for preventing unauthorized installation of computer software stored on an install storage medium, comprising the steps of: associating a character string with a volume label of a key storage medium; initiating communication between the key storage medium and a computer onto which the software is to be installed; verifying that the character string associated with the volume label of the key storage medium corresponds to a character string defined by the software contained on the install storage medium; and authorizing installation of the computer software from the install storage medium onto the computer.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a block diagram of a computer system with which one embodiment of the present invention can be utilized;

FIG. 2 is a flow diagram illustrating the operational steps of an embodiment in accordance with the present invention that can be used to prevent unauthorized installation of a software program;

FIG. 3 is a flow diagram illustrating the operational steps of an embodiment of the present invention that can be used to be prevent unauthorized execution of a software program;

FIG. 4 is a flow diagram illustrating the operational steps of another embodiment in accordance with the present invention that can be used to prevent unauthorized installation of a software program; and

FIG. 5 is a flow diagram illustrating the operational steps of an embodiment of the present invention that can be used to credit authorized un-installs of a software program.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

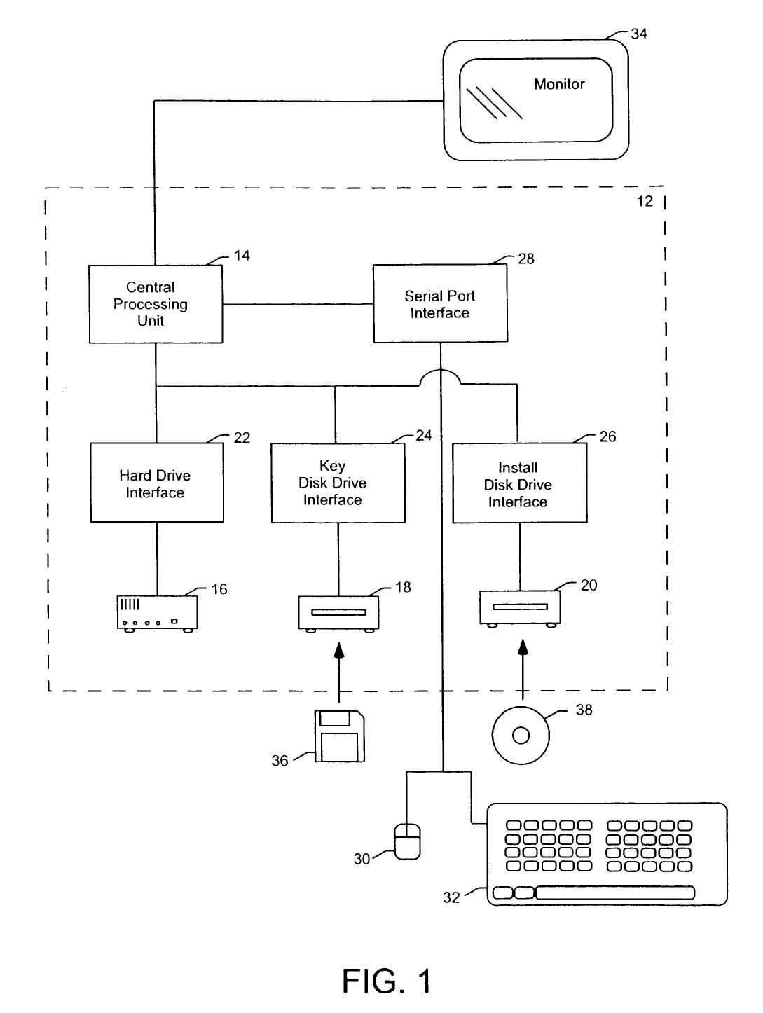

The present invention relates to a method for preventing unauthorized installation and use of a software program originally contained on an install storage medium through the use of a second, key storage medium. An example of a system with which the present invention can be used is illustrated in FIG. 1. Shown are a computer 12 which includes a central processing unit (“CPU”) 14. The CPU 14 is in communication with a hard drive 16, a key disk drive 18 and an install disk drive 20. A hard drive interface 22, a key disk drive interface 24 and an install disk drive interface 26 facilitate communication between the CPU and the hard disk drive, the key disk drive and the install disk drive, respectively. A serial port interface 28 facilitates communication between the CPU 14 and various serial devices, such as mouse 30 and keyboard 32. A monitor 34 allows output information to be provided in visual form to an operator of the computer 12.

FIG. 1 illustrates a key disk or storage medium 36 and an install disk or storage medium 38. While the embodiment in FIG. 1 shows the key disk as a magnetic floppy disk and the install disk as an optical CD-ROM disk, it is understood that any memory medium can be used as either the key or install disk or storage medium. The key and install disk drives can be one and the same, that is, the present invention can be utilized if only a rewritable CD-ROM drive is present in the computer, with no other secondary disk drive present. In such a case, a second disk drive is not necessary, as the operator can be prompted to insert the key and install disks at alternate times, as appropriate.

The present invention is directed to preventing unauthorized installation and use of software contained on the install disk by use of the key disk. The present invention utilizes unique attributes of the key disk and files stored on the key disk to ensure that the key disk is original and has not been altered. Thus, the key disk can control the number of installations of the software contained on the install disk. An operator can be prompted by the computer upon attempting to install the software to insert the key disk 36 into the key disk drive 24. If the file and disk attributes, as described in further detail below, match file and disk attribute information defined by the software, then installation of the software is authorized. If the file and disk attributes do not match, installation or use of the software is not authorized and the operator can be prompted to contact the software vendor to proceed.

It is to be understood that the example of personal computer 12 shown in FIG. 1 is for illustrative purposes only. Components other than those shown in FIG. 1 may be required for useful functioning of the computer, and are understood to be disclosed herein. Similarly, additional components which serve to facilitate input and output of information, such as a video card disposed between the CPU and the monitor, are not specifically referenced herein but are nonetheless considered a part of the disclosure herein.

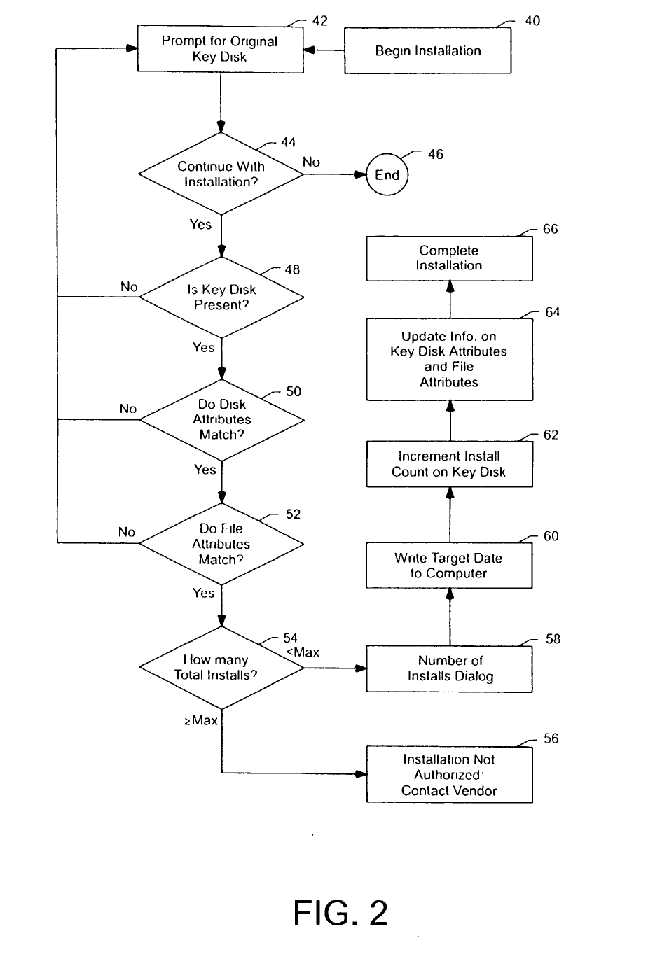

As illustrated in FIG. 2, a method in accordance with the present invention is shown for preventing unauthorized installation of computer software. The installation process, which can be initiated by an operator of a computer, either manually or by triggering an auto-install routine, is begun at 40. The install disk or medium can be any computer storage medium known to those skilled in the art, such as an optical disk, magnetic storage medium, flash RAM, or other digital storage medium. After installation has begun, communication is initiated between a key storage medium and the computer onto which the software is attempted to be installed. Similarly, the key storage medium can be any computer storage medium known to those skilled in the art, such as an optical disk, magnetic storage medium, CD, DVD, or other digital storage medium.

Communication between the computer and the key disk or storage medium can be initiated by prompting the operator to insert the key disk or medium into the key disk drive. During the prompting dialog, the operator can be informed of the purpose of the key disk and can be provided with the option of continuing or aborting the installation process at 44. If installation is canceled, the program ends at 46. If the operator wishes to continue, the presence of the key disk or storage medium is verified at 48. If the key disk is present, the process continues to the next step of verifying disk attributes of the key disk at 50.

Disk attributes of the key disk are verified at 50. The software can include a set of defined disk attributes that the software can check against the disk attributes of the key storage medium in order for installation to proceed. Disk attributes can include a disk serial number, a character string associated with a volume label of the key disk, disk formatting information, and information relating to a number and identity of files contained on the key disk or storage medium. The key disk attributes are compared with the set of defined disk attributes to verify that the key disk is original and that it has not been copied or altered. The defined disk attributes can be hidden embedded or encrypted within the software to prevent an operator or an end user from identifying the attributes and attempting to circumvent the anti-piracy method. Because the present invention can limit a total number of installations to a defined number of authorized installations, an operator may try to copy or alter the key disk in an effort to install more than the authorized number of installations. By copying or altering the key disk, the operator will have changed at least a portion of the disk attributes and will not be allowed to proceed with installation.

If the disk attributes of the key disk or storage medium correspond with the defined disk attributes, installation can progress to step 52 in where the method can verify that file attributes of files stored on the key storage medium correspond to file attributes defined by the software contained on the install storage medium. Because file attributes may have been changed by an operator by attempting to copy or alter the key disk or storage medium, the file attributes are verified to prevent unauthorized installation of the software. File attributes can be aspects of files such as date created, date modified, hidden, archived, size, read-only, author or creator, sharable, etc., as is known in the art. Because an operator attempting to copy or alter the key disk may not be aware that the file attributes are verified by software utilizing the present method, the present invention thus provides a method for thwarting attempts to circumvent the anti-piracy protection of the software. If the file attributes on the key disk or medium do not correspond with file attributes defined by the software, the operator is again prompted at 42 to install the original key disk or storage medium.

If the key file attributes match the defined file attributes, installation proceeds to 54 where a total number of installations of the software is determined. A vendor of the software may desire to limit the number of times a particular software can be installed. For instance, the vendor may allow an operator to install the software twice, and, upon attempting to install the software a third time without properly removing the earlier installations, the software can inform the operator that an installation must be uninstalled first. In this case, the max number of total installations is set at two. Of course, the total number can be set at any level the vendor desires, and the software can be provided with a number of licenses that correspond to the authorized number of installations.

If the total number of actual installations equals or exceeds the authorized maximum number of installations, the operator is notified at 56 that installation is not authorized and can be informed to contact the software vendor for more information. If the total number of actual installations is less than the max number of authorized installations, installation of the software proceeds to 58, where the operator can be informed of how many, if any, further installations are authorized. At this point, installation is authorized and a target date is written to the computer. The target date can be used to verify at a later anniversary date that installation of the software is still authorized, as will be discussed in further detail below. At 62, the actual install count contained on the key disk is incremented and any necessary update of the key disk attributes and file attributes of files contained on the disk are updated at 64, and installation is completed at 66.

The present method can be easily incorporated into all manner of software code to inexpensively and effectively prevent piracy of the software. Because the present invention does not rely on computer-specific information, changes to computer software (other than the software being protected) and hardware will not interfere with successful operation of the present invention.

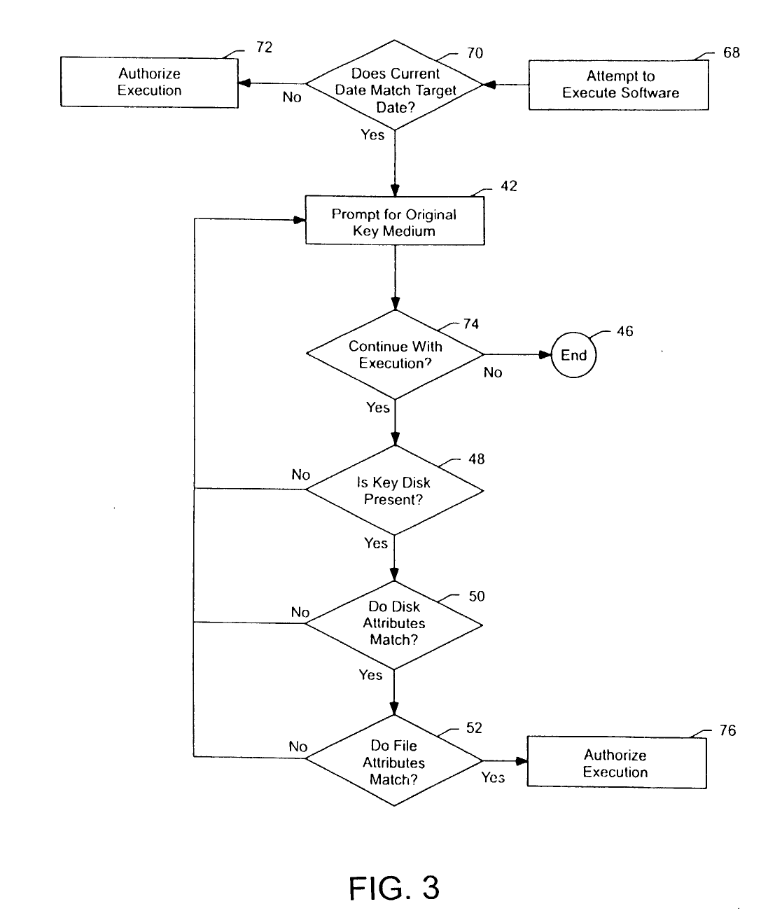

An alternative embodiment of the present invention is illustrated by the flowchart shown in FIG. 3. As shown in FIG. 3, the method begins with the step of executing the installed software at 68. Execution can be commenced by an operator attempting to run the software, or by the computer attempting to utilize the software to execute an executable file. After execution has begun, the current date from the computer is compared to a target date as defined by the software program.

In one embodiment, this defined target date is written to the computer during installation of the software, as is illustrated at 60 in FIG. 2. In addition to comparing the current date of the computer with a target date, a predetermined expiration of time can be used to trigger the present invention. For example, upon installation of the software, an elapsed-time subroutine can track the time that has elapsed since installation. After a pre-determined time which can be associated with the target date, such as 30 days or 1 year, the computer can be directed to prompt for the original key disk upon the next execution of the software program.

If the current date of the computer does not match the defined target date, execution is authorized at 72. If the current and target dates match, the program initiates communication between the computer and a key storage medium, and can prompt the operator to insert the original key medium at 42. At 74, the operator is given an opportunity to either continue with execution of the software or end, at 46. If the operator wishes to continue, the software checks for the presence of the key disk, and again prompts for the key disk if not present. If the key disk is present, the attributes of the key disk are compared at 48 with disk attributes as defined by the software. If the disk attributes match, the file attributes are compared at 50, and if they also match, execution of the software is authorized. If the disk or file attributes do not match, the operator is prompted for the original disk at 42 and again given the opportunity to continue or abort execution at 74.

As discussed above, disk attributes can include a disk serial number, a character string associated with a key volume label of the key disk, disk formatting information, and information relating to a number and identity of files contained on the key disk or storage medium. Similarly, file attributes can be aspects of files such as date created, date modified, hidden, archived, size, read-only, author or creator, sharable, etc.

It will thus be appreciated that the present invention provides a convenient and reliable method for preventing unauthorized use of software. Because an operator is periodically prompted to insert the key disk or storage medium, the software cannot be illegally used for extended periods of time. Further, because the present invention only periodically prompts for the key disk, an operator is not unnecessarily burdened by needing the key disk present every time the software is used.

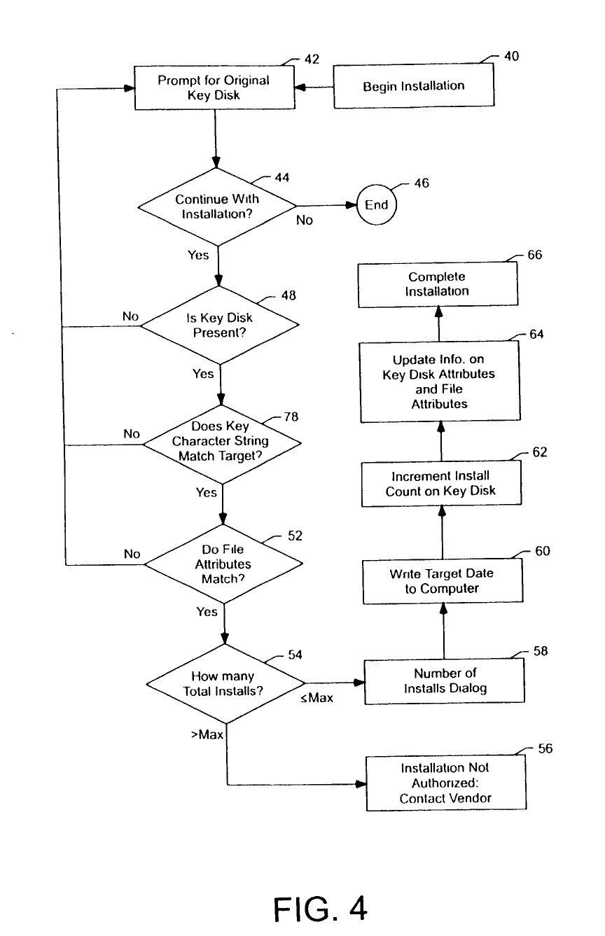

Illustrated by the flowchart in FIG. 4 is yet another embodiment of the present invention. This embodiment is similar to that shown in FIG. 2 and includes the additional step of comparing a character string associated with the key disk volume label. This embodiment includes the steps beginning at installation at 40 and proceeds, if positive results are achieved at each step, through step 48. In step 78, this embodiment compares a key character string associated with the volume label of the key storage medium with a character string defined by the software contained on the install storage medium. When the key character string matches, the installation of the software is authorized to proceed. In this way, the present invention is used to prevent unauthorized reproduction of the software onto the computer. Even if a user makes a copy of the software, the user may not be authorized to install the software onto a computer unless the key character string matches.

In this embodiment, a character string associated with a key disk volume label can be written to the volume label on the key disk and recorded in the software contained on the install disk. When a disk is copied, the disk label is not automatically copied by the computer. Thus, if an operator attempts to circumvent the present method by making a copy of the key disk the operator is unlikely to know that the character string associated with the key disk volume label needs to be copied, and the copied key disk will not pass the verification test. When verifying the key disk character string, the present invention will not typically alert an operator to the fact that the character string is being checked. If the key disk is rejected, the operator may not know why, and hence may not be tipped off to attempt to copy the original key volume label in order to circumvent the present anti-piracy system.

The step of selecting the character string or code string associated with the volume label can be done according to a specified font table. This embodiment can be utilized to write a volume label to the key disk using a font table that may not be readily available to the operator purchasing the software. As an example of how character translation can be done, the following lines were typed using identical keyboard keystrokes, except that the font for line I is Times New Roman and the font for line II is WP Japanese.

I: 1234567890abcdefghijklmnopqrstuvwxyzABCDEFGHIJKLMNOPQRSTUVWXYZ

II: 1234567890αβΦδεφγηιφκλμνοπθρστυ\overline{ω}ωξψζABXΔEΦΓHIΘKΛMNOπΘPΣTYçΩΞΨZ

If the character string associated with the key disk volume label was written in Times New Roman font as cdefghi, an operator attempting to view the volume label with WP Japanese font would only see a series of boxes, and would not know what the volume label is if he or she attempted to copy the volume label by entering it into the computer by hand. In addition to using standard keyboard strokes to write the character string, the character string can also be created according to a known code table, such as ASCII code. The present system would probably use characters at the end of a character set. For instance, if using extended ASCII codes, the keystrokes ALT-0-1-6-7 (which creates the character “§” in some U.S. font sets) could be used. Or, the key-strokes ALT-4 could be used which creates the character “□” in some U.S. font sets. Using this type of method, the character string can be made unintelligible in most languages or fonts. A software manufacturer could even develop its own, custom font table, and write the volume label accordingly using keystrokes that produce unintelligible symbols in a number of common fonts. In this manner, an operator attempting to copy the volume label (if the user even knows that the volume label must be copied) would be limited in his or her ability to do so, as the volume label would be unintelligible when written in the common fonts installed on his or her computer.

In one embodiment of the present invention, the step of selecting the specified font table can be done according to a geographic region or a language set associated with a geographic region to which the software is to be distributed. Hence, if a software manufacturer knows that a particular product is destined for a particular region, the key volume label can be written using character codes that do not translate into readable text in that region or that region's common language or font.

The specified font table can also be a “scrambled” font table that can be formed by scrambling the characters of a known font table such that the character string is legible only when viewed in the scrambled font. For instance, the font table can be created by inverting the known characters in a font from one end of the character numbering range to the other. In this example, the characters associated with the highest values or control character strings of a font table, which ordinarily may appear as illegible boxes, can be switched to correlate with what would normally be characters at the beginning of the font table. Thus, when viewed with the correct scrambled font table, the label might read “abcdefg,” but would only appear as a series of illegible symbols when viewed in a font other than the scrambled font. This scrambled font can be copied onto the user's computer when the program software is installed. Then when the label of the software storage medium is viewed by the user it will appear as an intelligible label. If the software storage medium is copied and the user enters the label for the copied medium by hand using a font other than the scrambled font, then the label will be the incorrect character string on another computer. Of course, the scrambling can be done according to any method preferred by the software creator, and can include completely random scrambling that might require one to possess a copy of the scrambled font table to decipher the volume label.

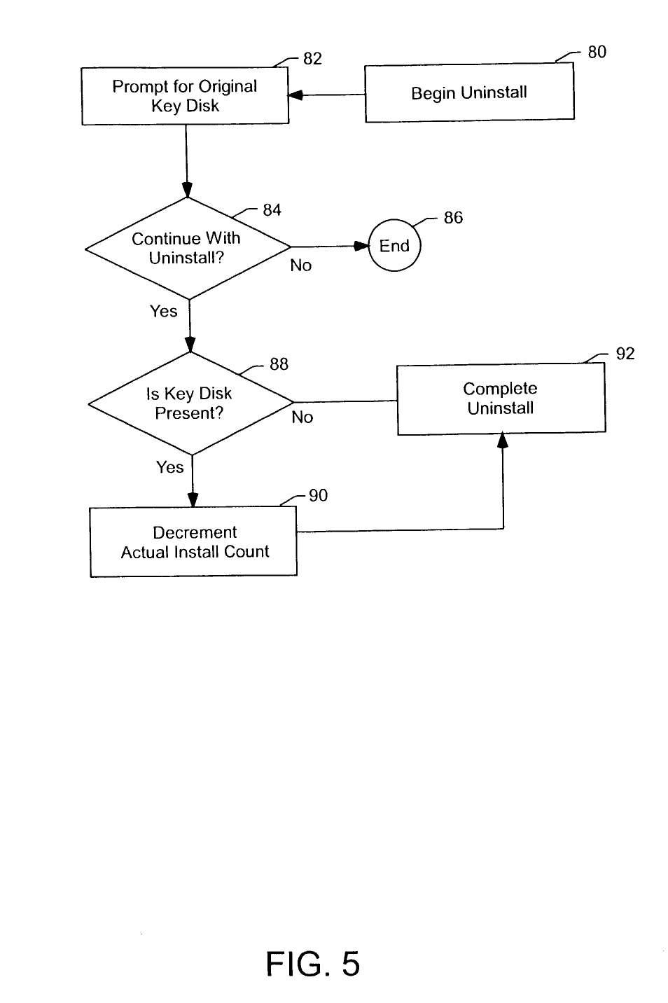

In accordance with another aspect of the present invention, as illustrated in FIG. 5, the method can include the further steps of uninstalling the software from the computer and decrementing the actual installation count contained on the key storage medium. In this manner, a total number of actual installations can be tracked. As an example, if an operator installs the software on one computer, for instance, a home computer, and then later decides that he or she would rather have the software installed on a laptop computer, the software can be uninstalled from the home computer and the operator will be “credited” with another authorized installation. If the operator was allowed only one installation, and used that on the home computer, the total number of actual installations would be returned to zero upon removal of the software from the home computer. The operator would then be free to install the software on the laptop computer.

As shown, an operator can begin the uninstall procedure at 80. If the present invention is used in conjunction with the software to be removed, the operator can be prompted for the original key disk at 82. At this step, the operator can be informed that if the key disk is not present, the operator will not be “credited” on the key disk with an uninstall and can be given the option to abort installation at 84. If the operator so chooses, the uninstall process ends at 86. If the operator wishes to proceed, the presence of the key disk is verified at 88. If the key disk is present, the actual install count is decremented at 90 and uninstall is completed at 92. If the key disk is not present, the uninstall can be completed at 92 without crediting the uninstall to the key disk. In this manner, an operator can install and uninstall the software as many times as desired, so long as the total number of actual installations does not exceed the maximum number of authorized installations.

It is to be understood that the above-referenced arrangements are only illustrative of the application for the principles of the present invention. Numerous modifications and alternative arrangements can be devised without departing from the spirit and scope of the present invention while the present invention has been shown in the drawings and fully described above with particularity and detail in connection with what is presently deemed to be the most practical and preferred embodiments(s) of the invention, it will be apparent to those of ordinary skill in the art that numerous modifications can be made without departing from the principles and concepts of the invention as set forth in the claims.

What is claimed is:

1. A method for preventing unauthorized installation of computer software stored on an install storage medium, comprising the steps of:
a) initiating communication between a key storage medium and a computer onto which the software is to be installed;
b) verifying that file attributes of files stored on the key storage medium correspond to file attributes defined by the software contained on the install storage medium; and
c) authorizing installation of the computer software from the install storage medium onto the computer.

2. A method in accordance with claim 1, further comprising the step of verifying that disk attributes of the key storage medium correspond to disk attributes defined by the software.

3. A method in accordance with claim 2, wherein disk attributes of the key storage medium include a serial number.

4. A method in accordance with claim 2, wherein disk attributes of the key storage medium include a character string associated with a key volume label.

5. A method in accordance with claim 1, further comprising the step of incrementing an actual installation count contained on the key storage medium.

6. A method in accordance with claim 5, further comprising the step of verifying that an actual number of installations of the software does not exceed a defined number of authorized installations by comparing the actual installation count contained on the key storage medium with an authorized installation count defined by the software.

7. A method in accordance with claim 5, further comprising the steps of:
a) uninstalling the software from the computer; and
b) decrementing the actual installation count contained on the key storage medium.

8. A computer storage medium having computer-executable instructions for performing the steps of claim 1.

9. A method for preventing unauthorized use of a software program installed on a computer, comprising the steps of:
a) reading a current date from the computer and verifying that the current date corresponds to a target date defined by the software program;
b) initiating communication between the computer and a key storage medium;
c) verifying that file attributes of files stored on the key storage medium correspond to file attributes defined by the software program; and
d) authorizing execution of the computer software by the computer.

10. A method in accordance with claim 9, further comprising the step of verifying that disk attributes of the key storage medium correspond to disk attributes defined by the software.

11. A method in accordance with claim 10, wherein disk attributes of the key storage medium include a serial number.

12. A method in accordance with claim 10, wherein disk attributes of the key storage medium include a character string associated with a key volume label.

13. A computer storage medium having computer-executable instructions for performing the steps of claim 9.

14. A method for preventing unauthorized installation of computer software stored on an install storage medium, comprising the steps of:
a) associating a character string with a volume label of a key storage medium;
b) initiating communication between the key storage medium and a computer onto which the software is to be installed;
c) verifying that the character string associated with the volume label of the key storage medium corresponds to a character string defined by the software contained on the install storage medium; and
d) authorizing installation of the computer software from the install storage medium onto the computer.

15. A method in accordance with claim 14, further comprising the step of authorizing reproduction of the software onto the computer after verifying that the label of the key storage medium corresponds to the character string defined by the software contained on the install storage medium.

16. A method in accordance with claim 14, further comprising the step of selecting the character string associated with the volume label according to a specified font table.

17. A method in accordance with claim 16, further comprising the step of selecting the specified font table according to a geographic region to which the software is to be distributed.

18. A method in accordance with claim 16, wherein the specified font table is a scrambled font table formed by scrambling the characters of a known font table such that the character string is legible only when viewed in the scrambled font table.

19. A method in accordance with claim 16, further comprising the step of selecting the specified font table according to a language set associated with a geographic region to which the software is to be distributed.

20. A method in accordance with claim 14 further comprising the step of incrementing an actual installation count contained on the key storage medium.

21. A method in accordance with claim 20, further comprising the step of verifying that a total number of installations of the software does not exceed a defined number of authorized installations by comparing the actual installation count contained on the key storage medium with authorized installation count defined by the software.

22. A method in accordance with claim 20, further comprising the steps of:
a) uninstalling the software from the computer; and
b) decrementing the actual installation count contained on the key storage medium.

23. A computer storage medium having computer-executable instructions for performing the steps of claim 14.
